(19) United States
(12) Patent Application Publication
(10) Pub. No.: US 2025/0317711 A1
(43) Pub. Date: Oct. 9, 2025

(54) INFORMATION PROCESSING DEVICE, RECEPTION DEVICE, INFORMATION PROCESSING METHOD, AND NON-TRANSITORY COMPUTER-READABLE STORAGE MEDIUM

(71) Applicant: JVCKENWOOD Corporation, Yokohama-shi (JP)

(72) Inventors: Masuhiro TAKEYAMA, Yokohama-shi (JP); Kenta HOSAKA, Yokohama-shi (JP); Yuji NISHINA, Yokohama-shi (JP); Moe FUJISHIMA, Yokohama-shi (JP)

(21) Appl. No.: 19/241,823

(22) Filed: Jun. 18, 2025

Related U.S. Application Data
(63) Continuation of application No. PCT/JP2023/036733, filed on Oct. 10, 2023.

(30) Foreign Application Priority Data
Dec. 19, 2022 (JP) 2022-202097

(51) Int. Cl. H04W 4/029

(52) U.S. Cl. CPC H04W 4/029

(57) ABSTRACT

An information processing device includes a history information acquisition unit which acquires outing histories of a plurality of third users specified based on first address information registered in a first transmission device, and second address information registered in a second transmission device; a destination determination unit which determines a reception device owned by a third user satisfying a specification condition as a destination of at least one of first specification information including first position information indicating a position of the first transmission device, and second specification information including second position information indicating a position of the second transmission device; and an information transmission unit which transmits at least one of the first and second specification information to the reception device determined as the destination.

### CROSS-REFERENCE TO RELATED APPLICATIONS

This application is a continuation of PCT Application No. PCT/JP2023/036733, filed on Oct. 10, 2023, and claims the priority of Japanese Patent Application No. 2022-202097, filed on Dec. 19, 2022, the entire contents of both of which are incorporated herein by reference.

### BACKGROUND ART

The present disclosure relates to an information processing device, a reception device, an information processing method, and a non-transitory computer-readable storage medium.

Conventionally, terminals have been known that provide information about a destination and provide guidance regarding a route to the destination so that a user can easily reach the destination.

Japanese Patent Application Publication No. 2022-085189 discloses a technology for providing information that can be shared among a plurality of users heading for the same destination. In the conventional technology disclosed in Patent Literature 1, information about each destination from a plurality of users is acquired, and a plurality of users who have a common destination are matched. Then, information is shared among the matched users, allowing the users to be provide with information that the matched users are interested in. Thus, for example, information can be shared among unacquainted users who participate in the same tour, so that users can communicate smoothly with each other.

### SUMMARY

However, in the conventional technology, specification information can be provided to users who are likely to heading for the destination at a timing before the users encounter each other at a destination. Therefore, if the action schedule of a specific user changes, other users may not be able to interact with the specific user, even if specification information is provided. Therefore, other users who expect to interact with the specific user may be less motivated to head for the destination. As a result, there is a problem that opportunities for outing for elderly people living alone, for example, may be reduced.

This disclosure provides an information processor, an information processing method and a storage medium capable of ascertaining encounter situations of a plurality of users.

An information processing device according to one or more embodiments includes: a history information acquisition unit configured to acquire outing histories of a plurality of third users specified based on first address information registered in a first transmission device owned by a first user; and second address information registered in a second transmission device owned by a second user; a destination determination unit configured to specify a third user satisfying a specification condition from among the plurality of third users based on the outing histories, and determine a reception device owned by the specified third user, as a destination of at least one of first specification information including first position information indicating a position of the first transmission device, and second specification information including second position information indicating a position of the second transmission device; and an information transmission unit configured to transmit at least one of the first specification information and the second specification information to the reception device determined as the destination, in which the destination determination unit instructs the information transmission unit to transmit at least one of the first specification information and the second specification information to the determined destination.

An information processing method by an information processing device according to one or more embodiments includes: acquiring outing histories of a plurality of third users specified based on first address information registered in a first transmission device owned by a first user and second address information registered in a second transmission device owned by a second user; specifying a third user satisfying a specification condition from among the plurality of third users based on the outing histories, and determining a reception device owned by the specified third user as a destination of at least one of first specification information including first position information indicating a position of the first transmission device and second specification information including second position information indicating a position of the second transmission device; and transmitting at least one of the first specification information and the second specification information to the reception device determined as the destination.

A non-transitory computer-readable storage medium according to a first aspect of the one or more embodiments acquires outing histories of a plurality of third users specified based on first address information registered in a first transmission device owned by a first user, and second address information registered in a second transmission device owned by a second user; specifies a third user satisfying a specification condition from among the plurality of third users based on the outing histories and determines a reception device owned by the specified third user as a destination of at least one of first specification information including first position information indicating a position of the first transmission device, and second specification information including second position information indicating a position of the second transmission device; and transmits at least one of the first specification information and the second specification information to the reception device determined as the destination.

According to one or more embodiments, it is possible to provide an information processing device, a reception device, an information processing method, and a non-transitory computer-readable storage medium capable of ascertaining encounter situations of a plurality of users.

### BRIEF DESCRIPTION OF DRAWINGS

FIG. 1 is a diagram illustrating a configuration example of an information processing system according to a first embodiment.

FIG. 2 is a diagram illustrating a hardware configuration example of an ECU of an in-vehicle unit.

FIG. 3 is a diagram illustrating a configuration example of ECU functions of an in-vehicle unit.

FIG. 4 is a diagram illustrating a hardware configuration example and a function configuration example of an information processing device of a server.

FIG. 5 is a flowchart for explaining an operation of an information processing system.

FIG. 6 is an external view of a movable body 3.

FIG. 7 is a diagram illustrating an example of information transmitted to a server and information transmitted to a user.

FIG. 8 is a view illustrating an example of information displayed on a first client device and a second client device owned by a first user and a second user, respectively.

FIG. 9 is a view illustrating an example of a map displayed on a third client device owned by a third user.

FIG. 10 is a view illustrating an example of information displayed on a third client device owned by a third user.

FIG. 11 is a view illustrating an example of a route guide display provided to a third user.

FIG. 12 is a diagram illustrating a configuration example of an information processing device according to a second embodiment.

FIG. 13 is a diagram illustrating a configuration example of an information processing device according to a third embodiment.

### DETAILED DESCRIPTION

### First Embodiment

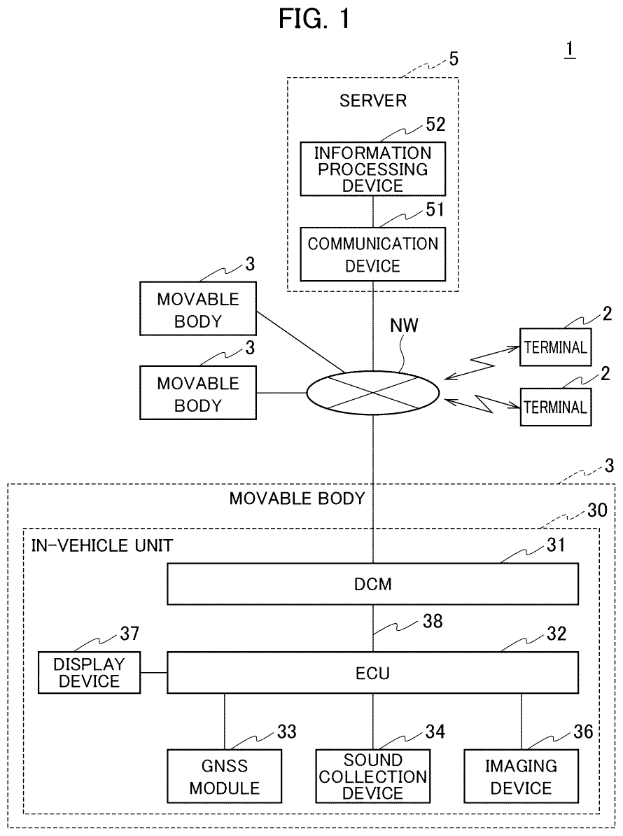

Hereinafter, an embodiment of the present invention will be described with reference to the drawings. FIG. 1 is a diagram illustrating a configuration example of an information processing system according to a first embodiment.

An information processing system 1 includes an in-vehicle unit 30 mounted on each of a plurality of movable bodies 3, a plurality of terminals 2, and a server 5 capable of communicating with the in-vehicle unit 30 and the terminals 2. The in-vehicle unit 30 and the terminals 2 are also referred to as client devices. The type of client devices may be only one of the in-vehicle unit 30 and the terminals 2. The information processing system 1 includes an optional client device among a plurality of the in-vehicle units 30 and a plurality of the terminals 2, and a server 5.

The movable bodies 3 include a mobility scooter, a passenger car, a cargo vehicle, a motorcycle, or the like. Hereinafter, the movable bodies 3 may be simply referred to as a vehicle.

The in-vehicle unit 30 includes a DCM (Data Communication Module) 31, an ECU (Electronic Control Unit) 32, a GNSS (Global Navigation Satellite System) module 33, a sound collection device 34, an imaging device 36, and a display device 37.

The DCM 31 is a communication device that performs bidirectional communication with external devices of a vehicle through a communication network NW. The communication network NW includes a mobile phone network with many base stations as terminals, a satellite communication network using communication satellites, or the like. The DCM 31 is connected to the ECU 32 through a CAN (Controller Area Network) 38, which is an in-vehicle network, so that the DCM 31 and the ECU 32 can communicate with each other. The DCM 31 transmits various kinds of information to external devices of the vehicle in response to requests from the ECU 32, and relays information transmitted from external devices of the vehicle to the ECU 32. The external devices include the server 5, the terminals 2, and V2X (vehicle to everything) communication devices (not illustrated). V2X is a communication technology that connects vehicles with various objects. V2X includes communications such as V2V (vehicle to vehicle), V2P (Vehicle to Pedestrian), V2I (vehicle to infrastructure), and V2N (vehicle to network).

The ECU 32 is an electronic control unit that performs various kinds of control processing related to predefined functions in a vehicle. Examples of the ECU 32 include a motor ECU, a hybrid ECU, and an engine ECU. The ECU 32 collects, for example, vehicle information, and inputs it to the DCM 31. The vehicle information includes vehicle position information, imaging information, sound information, or the like. The vehicle information may also include speed information, vehicle status information, or the like.

### (Vehicle Position Information)

Vehicle position information indicates a current position of a vehicle, for example, the latitude and longitude at which the vehicle is traveling. The vehicle position information is transmitted from the GNSS module 33 or the like. The GNSS module 33 receives a GNSS signal transmitted from a satellite, and measures a position of the vehicle on which the GNSS module 33 is mounted. The GNSS module 33 is communicably connected to the ECU 32 through the CAN 38, and the vehicle position information is transmitted to the ECU 32. The GNSS module 33 may include one provided by a car navigation system, one provided by a drive recorder, one mounted on a vehicle body, one provided by the terminal 2 owned by a user, or the like. Hereinafter, the vehicle position information may be simply referred to as position information.

### (Imaging Information)

Imaging information is information indicating content of the image captured by the imaging device 36. The imaging information includes time information indicating the time when the image was generated. The imaging device 36 is a camera including an imaging element such as a Charge Coupled Device (CCD) or Complementary Metal Oxide Semiconductor (CMOS).

The imaging device 36 includes an internal imaging device for imaging the interior of a vehicle, an external imaging device for imaging the exterior of a vehicle, or the like. The imaging device 36 may include a camera included in a drive recorder, a camera mounted on a vehicle body, a camera included in the terminals 2 owned by users, or the like.

The internal imaging device is arranged at a position where a face of an occupant or the like can be imaged. The number of internal imaging devices is not limited to one, but a plurality of internal imaging devices may be provided inside the vehicle. The internal imaging device outputs imaging information indicating a captured image of the inside of the vehicle.

The external imaging device includes a front camera, a rear camera, an omnidirectional camera, a panoramic camera, or the like, for imaging scene around the vehicle. Examples of the scene around the vehicle include, a scene in front of the vehicle, a scene on a side of the vehicle (a driver's door side of the vehicle or the passenger's door side of the vehicle), and a scene behind the vehicle. Examples of the sceneries includes, a scene of a destination of a user of the terminal 2 (such as a meeting place or park), a roadway on which the vehicle is traveling, objects on the roadway, sidewalks facing the roadway, and objects on the sidewalk. The external imaging device is arranged at a position where, for example, a scene outside the vehicle can be imaged. The external imaging device outputs imaging information indicating a captured image of the outside of the vehicle.

### (Sound Information)

Sound information may include the voice (sound) of a first user collected by a sound collection device 34, a sound around the first user, or the like. The sound collection device 34 may include a microphone included in a car navigation device, a microphone included in a drive recorder, a microphone mounted on a vehicle body, a microphone included in a terminal 2 owned by a user, or the like.

The display device 37 may be a liquid crystal display, or the like. The display device 37 may include one provided by a car navigation device, one provided by a drive recorder, one mounted on a vehicle body, one provided by the terminal 2 owned by a user, or the like.

The server 5 is a server that provides various services by collecting information from a plurality of vehicles and transmitting information (distributing information) to occupants of a plurality of vehicles. The server 5 may also provide various services by collecting information from the terminals 2 owned by the occupants of a plurality of vehicles, or the in-vehicle units 30 mounted on a plurality of vehicles and transmitting information (distributing information) to the terminals 2 owned by the occupants of another vehicle, or the in-vehicle units 30 mounted on another vehicle.

The various services are information transfer services, or the like. The information transfer services may include transferring, for example, video data, sound data, and position information collected by a specific terminal 2 or the in-vehicle unit 30 to another terminal 2 or another in-vehicle unit 30. The various services are not limited to the information transfer services, but may include car sharing services, authentication key services, trunk delivery services, B2C car sharing services, advertisement distribution services, or the like.

The server 5 includes a communication device 51 and an information processing device 52. The communication device 51 is a communication device t performs bidirectional communications with a plurality of the in-vehicle units 30 or a plurality of the terminals 2 through the communication network NW under control of the information processing device 52. The information processing device 52 executes various types of control processing in the server 5. The information processing device 52 includes a server computer including, for example, a Central Processing Unit (CPU), a Random Access Memory (RAM), a Read Only Memory (ROM), an auxiliary storage device, and an input/output interface.

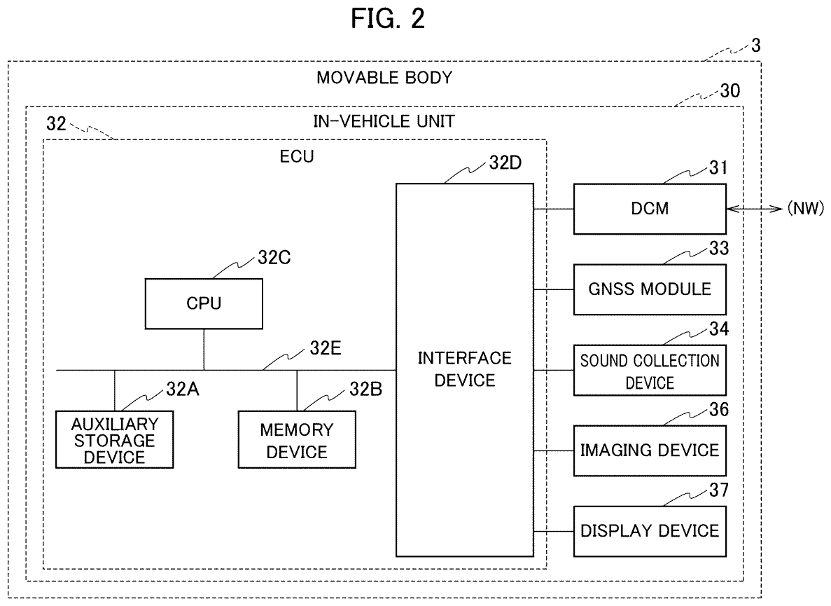

Next, a hardware configuration of the ECU 32 of the in-vehicle unit 30 will be described with reference to FIG. 2. FIG. 2 is a diagram illustrating a hardware configuration example of the ECU 32 in the in-vehicle unit 30. The ECU 32 includes an auxiliary storage device 32A, a memory device 32B, a CPU 32C, and an interface device 32D. These devices are connected to each other by a bus line 32E.

The auxiliary storage device 32A is a hard disk drive (HDD), flash memory, or the like, that stores files and data required for processing by the ECU 32. The memory device 32B reads and stores a program from the auxiliary storage device 32A when a program start instruction is given. The CPU 32C executes a program stored in the memory device 32B and implements various functions of the ECU 32 according to the program. The interface device 32D is, for example, an interface that connects the CPU 32C to the DCM 31 via the CAN 38, and connects the imaging device 36 or the like to the DCM 31 via the CAN 38.

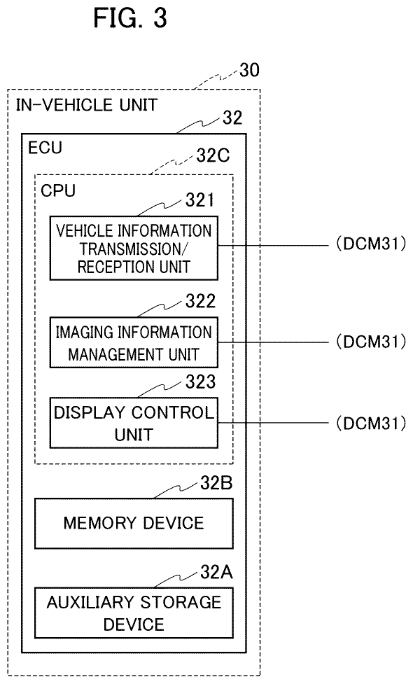

Next, the functions of the ECU 32 in the in-vehicle unit 30 will be described with reference to FIG. 3. FIG. 3 is a diagram illustrating a configuration example of the functions of the ECU 32 in the in-vehicle unit 30.

The CPU 32C of the ECU 32 includes a vehicle information transmission/reception unit 321, an imaging information management unit 322, and a display control unit 323.

The vehicle information transmission/reception unit 321 has a function of transmitting the vehicle position information, imaging information, sound information, or the like described above to the server 5 as vehicle information; and a function of receiving information from the server 5.

The imaging information management unit 322 performs processing such as embedding time and vehicle position information in the imaging information while inputting the imaging information transmitted from the imaging device 36 for a defined period of time. The display control unit 323 performs processing such as displaying a map including a current position of the vehicle on a display, and displaying a scene outside of the vehicle that is captured by the camera on the display.

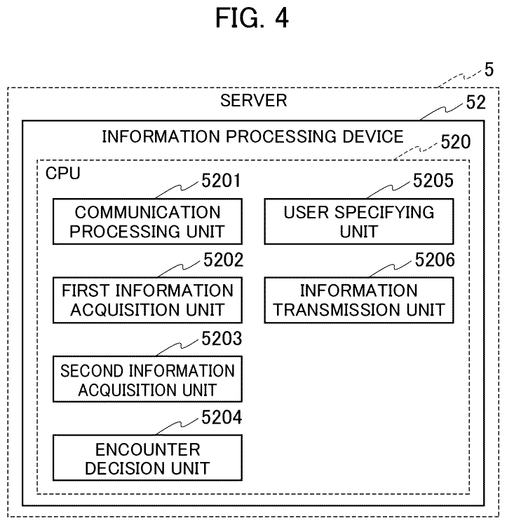

Next, with reference to FIG. 4, a hardware configuration example of an information processing device of a server will be described. FIG. 4 is a diagram illustrating a hardware configuration example, and a function configuration example of a server information processing device. The information processing device 52 includes a CPU 520 and a storage unit (not illustrated).

The CPU 520 includes a communication processing unit 5201, a first information acquisition unit 5202, a second information acquisition unit 5203, an encounter determination unit 5204, a user specifying unit 5205, and an information transmission unit 5206.

The communication processing unit 5201 transmits and receives signals to and from a plurality of the in-vehicle units 30 and/or a plurality of the terminals 2. Specifically, the communication processing unit 5201 transmits and receives Protocol Data Units (PDU) and Service Data Units (SDU).

### (First Information Acquisition Unit 5202)

The first information acquisition unit 5202 acquires, as first information, first specification information for specifying a first user, and first address information registered in the terminal 2 owned by the first user or registered in the in-vehicle unit 30 included in the vehicle that the first user rides. The terminal 2 owned by the first user, or the in-vehicle unit 30 included in the vehicle that the first user rides, is also called a first client device (first transmission device) owned by the first user. The first information acquisition unit 5202 may acquire first address information stored in a storage unit (not illustrated) owned by the server 5.

Specifically, the first information acquisition unit 5202 acquires, as first specification information for specifying the first user, first position information indicating the position of the first client device. The first position information is information indicating a current position of the first client device, for example, information indicating the latitude and longitude at which the vehicle is traveling. The first position information is transmitted from the GNSS module 33 or the like owned by the first client device. The first information acquisition unit 5202 acquires, as first specification information for specifying the first user, sound data collected by the first client device. The first information acquisition unit 5202 acquires, as first specification information for specifying the first user, image data collected by the first client device.

By acquiring the position information, the server 5 can specify a rough position of a place where the first user is located, such as a meeting place where the first user is facing a friend, a venue of an event in which the first user is participating, or the like, and can transmit a specified position to the terminal 2 owned by a specific user (for example, a third user) who is acquainted with the first user, or to the in-vehicle unit 30 in the vehicle that the third user rides. The terminal 2 owned by the third user, or the in-vehicle unit 30 included in the vehicle that the third user rides, is also called a third client device (reception device) owned by the third user.

The sound data includes the voice (sound) of the first user, a sound around the first user, or the like. The sound data is not limited to data collected by the first client device of the first user, and may be collected by a sound collecting device other than a drive recorder or the in-vehicle unit 30 mounted on the vehicle body. By acquiring the sound data, a server 5 can transmit the sound of the first user, a conversation between the first user and his friend (for example, a second user), a sound collected at a venue of an event in which the first user is participating, or the like, to a third client device owned by a specific user (for example, a third user) who is acquainted with the first user.

Image data includes an image of the first user, a scene image including the first user, a scene image around the first user, or the like. The image data is not limited to data collected by the first client device owned by the first user, and may be collected by an imaging device other than a drive recorder included in the vehicle that the first user rides, or the in-vehicle unit 30 mounted on the vehicle body.

The first address information is information (such as name, phone number, address) for specifying one or more persons recorded in an address book previously registered in the first client device owned by the first user. The first address information may be address information managed by the server 5 as information related to the first user. The first address information may be, for example, address information stored in a storage unit (not illustrated) included in the server 5 that has been registered in advance by either the first user, the second user, the third user, or any other third person.

### (Second Information Acquisition Unit 5203)

The second information acquisition unit 5203 acquires, as second information, second specification information for specifying a second user, and second address information registered in the terminal 2 owned by the second user or the in-vehicle unit 30 included in the vehicle that the second user rides. The terminal 2 owned by the second user, or the in-vehicle unit 30 owned by the vehicle that the second user rides, is also called a second client device (second transmission device) owned by the second user. The second information acquisition unit 5203 may acquire second address information stored in a storage unit (not illustrated) included in the server 5.

Specifically, similar to the first information acquisition unit 5202, the second information acquisition unit 5203 acquires, as second specification information for specifying a second user, second position information indicating the position of the second client device, sound data collected by the second client device, image data collected by the terminal 2, or the like.

By acquiring the position information, the server 5 can specify a rough position of a place where the second user is located, such as a meeting place where the second user is facing a friend, a venue of an event in which the second user is participating, or the like, and can notify a specified position to a third client device owned by a specific user (for example, a third user) who is acquainted with the second user.

Sound data includes the voice (sound) of the second user, a sound around the second user, or the like. The sound data is not limited to data collected by the second client device owned by the second user, and may be collected by a sound collecting device other than the in-vehicle unit 30 included in the vehicle that the second user rides. By acquiring the sound data, the server 5 can notify the voice of the second user, a conversation between the second user and his friend (for example, the first user), a sound collected at a venue of an event in which the second user is participating, or the like, to a third client device owned by a specific user (for example, a third user) who is acquainted with the second user.

The image data includes an image of the second user, a scene image including the second user, a scene image around the second user, or the like. The image data is not limited to data collected by the second client device owned by the second user, and may be collected by an imaging device other than a drive recorder included in the vehicle that the second user rides, or the in-vehicle unit 30 mounted on the vehicle body.

The second address information is information (such as name, phone number, address) for specifying one or more persons recorded in an address book previously registered in the second client device owned by the second user. The second address information may be address information managed by the server 5 as information related to the second user. The second address information may be, for example, address information stored in a storage unit (not illustrated) included in the server 5 that has been registered in advance by any of the first user, the second user, the third user, or other third parties.

### (Encounter Determination Unit 5204)

The encounter determination unit 5204 determines whether or not a first user and a second user have encountered each other, based on first specification information and second specification information.

### Decision Example 1

Specifically, the encounter determination unit 5204 determines whether or not a distance between a position of the first user acquired by the first information acquisition unit 5202 and a position of the second user acquired by the second information acquisition unit 5203 is shorter than a specific distance, based on the first position information and the second position information indicating the positions of the first client device and the second client device owned by the first user and the second user, respectively.

Examples of the specific distance may include 5 m, 10 m, 30 m. The specific distance may be automatically set to a value suitable for a location where a user is located, or may be set to any value by the user. When the encounter determination unit 5204 determines that the distance between the first user and the second user is shorter than the specific distance, it activates a timer to determine whether the distance is shorter than the specific distance even after a certain time has elapsed.

When the distance is shorter than the specific distance even after a certain time has elapsed, the encounter determination unit 5204 determines that the first user and the second user have encountered each other at a common destination of the first user and the second user. Thus, specification information can be transmitted to a third user only when the first user and the second user are gathered at the specific destination for the same purpose, that is, except for a state where the first user and the second user pass each other on the road by accident. Details of the specification information transmitted to the third user will be described below.

When the distance is longer than the specific distance before a certain time has elapsed, the encounter determination unit 5204 determines that the first user and the second user have not encountered each other. For example, when the first user and the second user meet each other by accident at a specific place, the first user may move away from the second user before a certain time has elapsed, and the distance between the first user and the second user may become longer than the specific distance. In this way, if the distance becomes longer than the specific distance before a certain time elapses in the timer, it is determined that the first user and the second user have not encountered each other at the common destination of the first user and the second user, so that transmission of specification information to the third user can be prevented when the first user and the second user have not gathered at a specific destination for the same purpose. Thus, transmission of unnecessary information can be prevented, and the load of the server 5 and the network NW can be prevented from increasing.

### Decision Example 2

The encounter determination unit 5204 may use sound data instead of the first position information and the second position information, or together with the first position information and the second position information. Specifically, the encounter determination unit 5204 analyzes the sound included in the sound data acquired by the first information acquisition unit 5202, and if the analyzed sound matches the sound of a previously registered second user, it determines that the second user is located around the first client device owned by the first user at the common destination of the first user and the second user. A technology for analyzing a sound and determining whether the sound matches is known, for example, as disclosed in JP 2001-338069 A.

In this case, the encounter determination unit 5204 activates the timer as described above, and if the analyzed sound matches the sound of a previously registered second user even after a certain time elapses, it determines that the second user is located around the first client device owned by the first user, that is, the first user and the second user have encountered each other.

If the sound of the second user is not extracted before a certain time elapses, the encounter determination unit 5204 determines that the first user and the second user have not encountered each other.

By using the sound data, even if the first user and the second user are located indoors or underground, the encounter determination unit 5204 can decide that the second user is located near the first client device, that is, it is highly possible that the first user and the second user have encountered each other. That is, it is particularly useful when a GNSS signal reception environment is bad. By using the sound data and the position information together, the determination the encounter reliability of the determination unit 5204 can be improved.

### Decision Example 3

The encounter determination unit 5204 may use image data instead of the first position information and the second position information, or together with the first position information and the second position information. Specifically, the encounter determination unit 5204 analyzes the image data acquired by the first information acquisition unit 5202, and if an analyzed face image matches a face image of a second user previously registered, determines that the second user is located around the first client device owned by the first user. A technology for analyzing an image and determining coincidence of face images is known, for example, as disclosed in JP 2022-122098 A.

In this case, the encounter determination unit 5204 activates the timer in the same manner as described above, and determines that the first user and the second user have encountered each other if the second user still is located in the image captured by the first client device owned by the first user after a certain time has elapsed in the timer.

If the second user is no longer located in the image captured by the first client device owned by the first user before a certain time has elapsed in the timer, the encounter determination unit 5204 determines that the first user and the second user have not encountered each other.

By using image data, an effect similar to that of using sound data can be obtained. This is particularly useful when the sound data cannot be utilized due to noise generated around the user to be imaged. By using position information and image data together, the reliability of the determination by the encounter determination unit 5204 can be improved.

The encounter determination unit 5204 may decide whether or not the first user and the second user have encountered each other by combining at least two of the first position information and the second position information; sound data; and image data.

### (User Specifying Unit 5205)

When the first user and the second user encounter each other, the user specifying unit 5205 specifies a third user based on the first address information and the second address information.

Specifically, when the encounter determination unit 5204 determines that the first user and the second user encounter each other, the user specifying unit 5205 compares information (for example, a full name) specifying one or more persons included in the first address information acquired by the first information acquisition unit 5202 with information specifying one or more persons included in the second address information acquired by the second information acquiring unit 5203.

When a matched full name is included as a result of the comparison, the person with the full name is specified as a friend or acquaintance (third user) common to the first user and the second user, and address information of the third client device owned by the third user included in the first address information or the second address information is acquired. One or more third users may be specified.

### (Information Transmission Unit 5206)

The information transmission unit 5206 transmits at least one of the first specification information and the second specification information to a third client device owned by a third user.

Specifically, the information transmission unit 5206 transmits at least one of the first position information or the second position information, sound data collected by the first or second client device, and image data collected by the first or second client device to the address of the third client device owned by the third user specified by the user specifying unit 5205.

By transmitting the position information, the information transmission unit 5206 can notify positions in which the first user and the second user are located to the third client device owned by the third user of the position. It is also possible to make the third client device owned by the third user display a route from the positions in which the first user and the second user are located to the position of the third user.

By transmitting the sound data, the information transmission unit 5206 can make the third client device owned by the third user reproduce sounds around the place where the first user and the second user are located, sounds of the first user and the second user, or the like.

By transmitting data, the information transmission unit 5206 can make the third client device owned by the third user display images around the place where the first user and the second user are located, facial expressions of the first user and the second user, or the like.

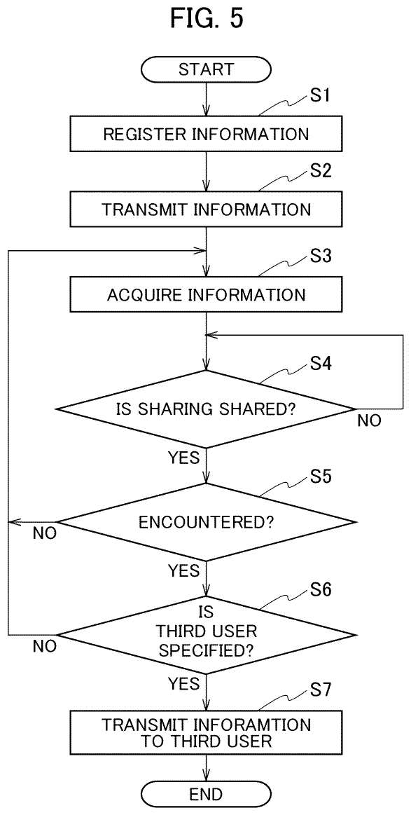

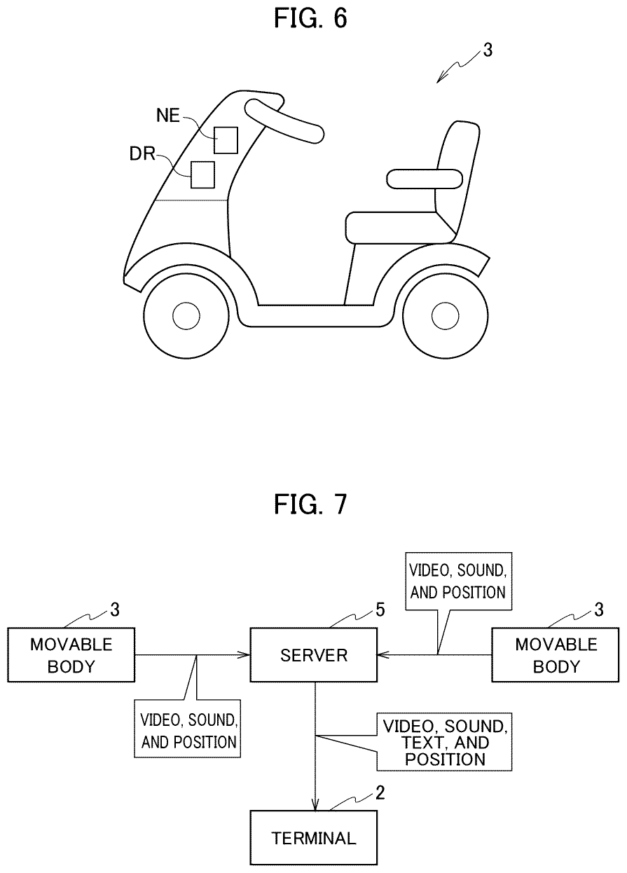

Next, the operation of the information processing system 1 will be described. FIG. 5 is a flowchart for explaining the operation of the information processing system. FIG. 6 is an external view of the movable body 3. FIG. 6 illustrates a drive recorder DR, a navigation device NE, and the like as examples of the in-vehicle unit 30 mounted on the movable body 3.

FIG. 7 is a diagram illustrating an example of information transmitted to a server and information transmitted to a user. FIG. 7 illustrates information transmitted to the server 5 from the in-vehicle unit 30 (first client device) included in the movable body 3 that the first user rides. FIG. 7 also illustrates information transmitted to the server 5 from the in-vehicle unit 30 (second client device) included in the movable body 3 that the first user rides. FIG. 7 also illustrates information transmitted from the server 5 to the terminal 2 (third client device) of a third user. The information includes videos in a facility in which a user is located, sounds collected in the facility, texts generated by transcribing the sounds, and a position where the user is located.

Hereinafter, an operation example in which the first and second users on the movable body 3 encounter each other and transmit information to a third client device owned by the third user will be described with reference to FIG. 5. The user of the movable body 3 registers his/her full name, vehicle information, and the like as his/her own information in advance by using specific application software installed in a client device (step S1).

When the first and second users move to a destination using the movable body 3, video data, sound data, and position information are transmitted from the first and second client devices owned by the first and second users to the server 5 (step S2). Thus, the server 5 acquires video data, sound data, and position information acquired by the first and second client devices (step S3).

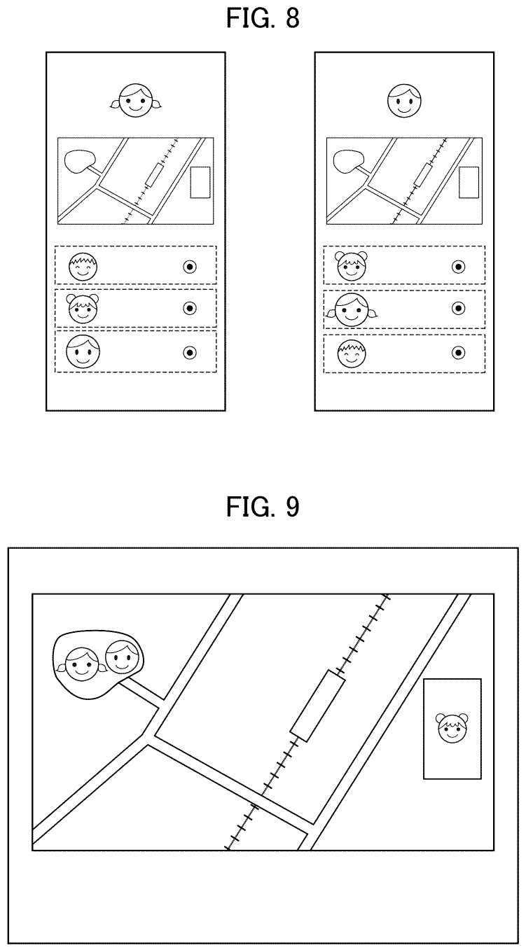

FIG. 8 is a view illustrating an example of information displayed on the first client device and second client device owned by the first user and the second user, respectively. Each user of the movable body 3 can select a user who is permitted to share information by using specific application software installed in the client device.

For example, when the first user shares information with the second user, the sharing of information with the second user can be permitted by pressing an icon (permission/non-permission button) associated with an image specifying the second user displayed on the screen.

When the first user shares information with the third user, the sharing of information with the third user can also be permitted by pressing the icon (permission/non-permission button) associated with the image specifying the third user displayed on the screen. Thus, one or more users to share information can be designated.

If the sharing of information is not permitted (step S4: NO), processing of step S4 is repeated until permission is granted. If the sharing of information is permitted (step S4: YES), processing of step S5 is executed.

If the second user has not encountered the first user permitted to share information (step S5: NO), processing of step S3 and subsequent steps is repeated. When the second user encounters the first user permitted to share information (step S5: YES), processing of step S6 is executed.

When a common user among one or more users included in the first address information and the second address information is not specified as the third user (step S6: NO), processing of step S3 and subsequent steps are executed. When the common user is specified as the third user (step S6: YES), processing of step S7 is executed.

The server 5 transmits at least one of first position information indicating the position of the first client device owned by the first user, sound data collected by the first client device, and image data collected by the first client device to the third client device owned by the specified third user (step S7). In place of the first position information, second position information indicating the position of the second client device owned by the second user who encounters the first user may be transmitted.

FIG. 9 is a view illustrating an example of a map displayed on a third client device owned by a third user. FIG. 9 illustrates a map displayed on the third client device owned by the third user who is permitted to share information. In addition, an icon for specifying each user permitted to share information is illustrated on the map. The icon of each user is associated with a place where each user is located. When the user uses the movable body 3, the client device may display the icon of the movable body 3 in combination with the icon of the user. When the sharing of information is permitted, the icon for specifying each user is displayed on the screen of each client device superimposed on the map. Thus, the user of each client device can easily confirm where each user currently is located.

By the processing of step S7, the server 5 transmits to the third client device owned by the third user a video or the like of a facility in which the first user is located when the second user encounters the first user. Thus, the third client device displays a video or the like of the facility. Similarly, by transmitting to the first client device owned by the first user an image or the like of the facility in which the third user is located, the first client device may display a video or the like of the facility.

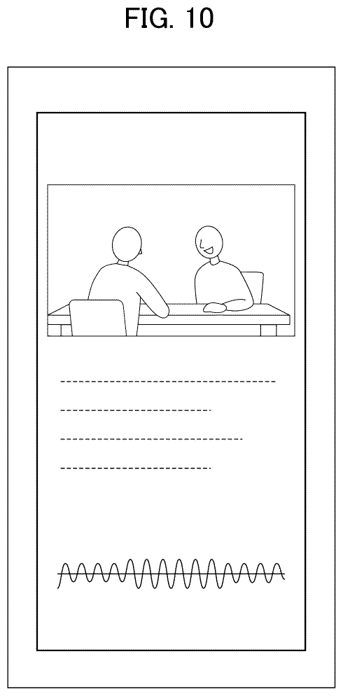

FIG. 10 illustrates a display example of a screen of a third client device owned by a third user. The third client device displays a video of a facility in which the first user and the second user are located (upper row of FIG. 10), a text generated by transcribing sounds collected at the facility (middle row of FIG. 10), or the like. The third client device also reproduces the sounds collected at the facility. The third client device may display an image illustrating a waveform of the sound being reproduced (lower row of FIG. 10).

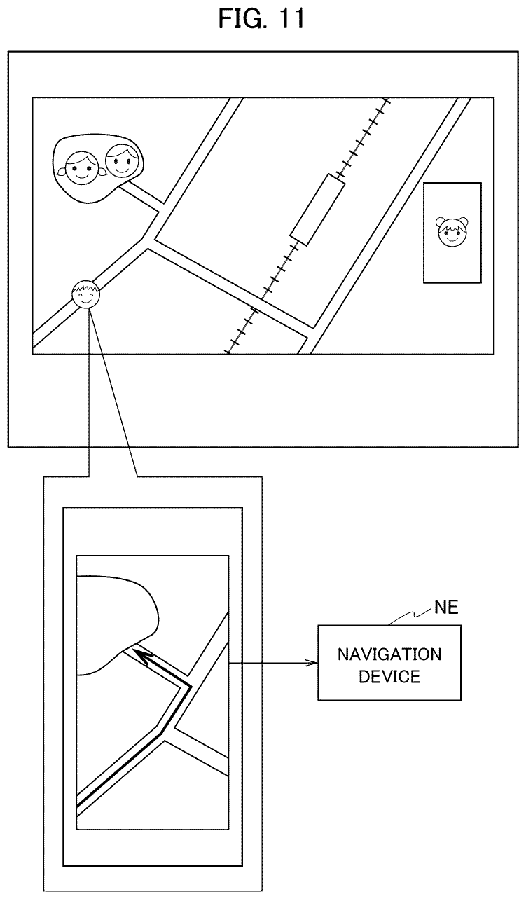

FIG. 11 is a view illustrating an example of a route guide display provided to a third user. The third user who has confirmed the video in the facility in which the first user and the second user are located taps the icon of the first user displayed on a screen by an application installed in the third client device. Thus, the third client device automatically sets a travel route from the position of the third user to the position of the first user.

A travel route that has been set may be transferred from a third client device to a navigation device. Thus, the third user can easily move to a place where the first user is located while checking the screen of the navigation device without checking a smartphone or the like.

### (Effect)

As described above, when the information processing device 52 according to the present embodiment determines that the first user and the second user have encountered each other, based on the first specification information and the second specification information, the third user who is a common friend of the first user and the second user is specified, and at least one of the first specification information and the second specification information is transmitted to the third client device owned by the third user.

In the conventional technology, however, specific information is provided to the third user at a timing that is a certain time before a point at which the first user and the second user actually encounter each other at a destination, as described above. Therefore, even if the specific information is provided at the timing, the third user may not be able to interact with the first user and the second user when action schedules of the first user and the second user subsequently change.

With the information processing device 52 according to the present embodiment, the third user can ascertain the encounter situations of a plurality of users by the configuration described above. For example, the third user can confirm situations in which the first user and the second user actually encounter each other, so that the willingness of the third user to go to the destination to interact with the first user or the like can be improved. As a result, it is possible to obtain an effect that not only elderly people living alone, but also young people who are avoid social interaction (are withdrawn), can have an improved opportunity to go out.

In addition, with the information processing device 52 according to this embodiment, information is automatically transmitted to the third user when the first user and the second user encounter each other, so that a specific operation of the client device can be reduced. The examples of the specific operation includes an operation by either the first user or the second user to input a message to invite the third user, an operation for making a telephone call, or the like. Therefore, a burden on the first user and the second user can be reduced. Moreover, the amount of labor and effort to explain the current location to the third user can be reduced.

### Second Embodiment

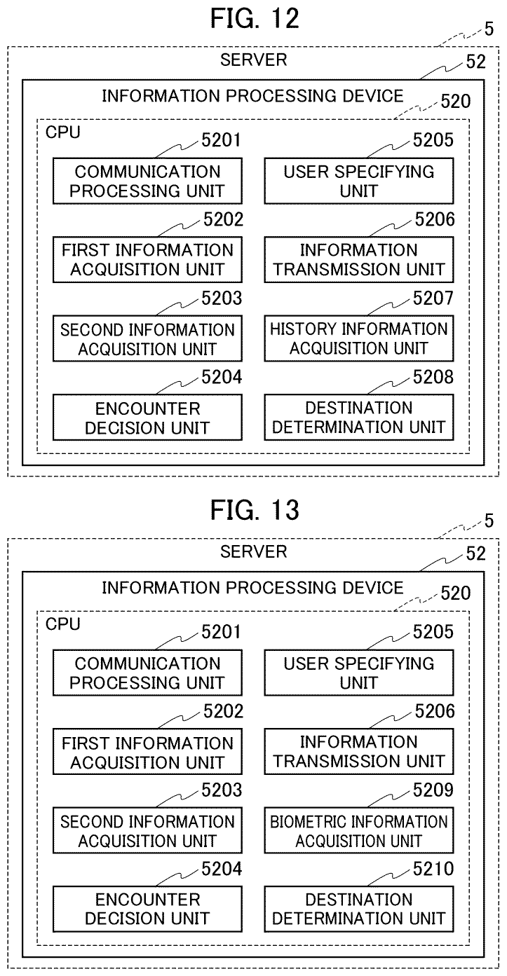

Next, a second embodiment of the present invention will be described. FIG. 12 is a diagram illustrating a configuration example of an information processing device according to the second embodiment. As illustrated in FIG. 12, the information processing device 52 according to the second embodiment includes a history information acquisition unit 5207 and a destination determination unit 5208 in addition to the functions of the information processing device 52 according to the first embodiment.

The history information acquisition unit 5207 acquires outing histories of a third user specified by the user specifying unit 5205. Specifically, the history information acquisition unit 5207 transmits a transmission request message for the outing histories to a third client device owned by the specified third user. Thus, the third client device extracts outing histories of the third user moving from home to another place from histories of position information recorded in the third client device, and transmits it to the server 5. The outing histories may include an outing frequency, an outing destination, an outing date and time, and an outing means of the third user. The outing histories may be those corresponding to a plurality of third users.

Based on the outing histories acquired by the history acquisition unit 5207, the destination information determination unit 5208 specifies a third user satisfying the specification condition from among the plurality of third users, and determines the reception device owned by the specified third user as a destination of at least one of the first specification information and the second specification information. The destination determination unit 5208 instructs the information transmission unit 5206 to transmit at least one of the first specification information and the second specification information to a determined destination.

Specifically, when there are a plurality of specified third users, the destination determination unit 5208 refers to their respective outing histories, and under a specification condition that outing frequency is less than the specified number of times, classifies the third users into, for example, a third user satisfying the specification condition of outing frequency less than the specified number of times, and a third user not satisfying a specification condition and having outing frequency more than or equal to the specified number of times.

The destination determination unit 5208 determines a third user satisfying the specification condition as a destination of at least one of the first specification information and the second specification information for a certain period of time. The destination determination unit 5208 instructs the information transmission unit 5206 to transmit information to a determined destination (the third user). The information transmission unit 5206 transmits information to the determined destination (the third user).

As a result, the transmission range can be narrowed to users who go out less frequently, and the video or the like can be preferentially distributed, thereby reducing the load on the network NW.

Moreover, the users who go out less frequently may lose their motivation to go out if many videos are transmitted. Therefore, it is possible to effectively encourage them to go out by transmitting video or the like only for a certain period of time (that is, to the extent to attract their attention).

Incidentally, the destination determination unit 5208 may determine a third client device owned by a third user satisfying the specification condition as a destination of at least one of the first specification information and the second specification information for a certain period of time under a specification condition that outing frequency is more than or equal to the specified number of times. Thus, the user who goes out frequently can also increase their opportunity to meet an acquaintance.

### Third Embodiment

FIG. 13 is a diagram illustrating a configuration example of the information processing device according to a third embodiment. As illustrated in FIG. 13, the information processing device 52 according to the third embodiment includes, in addition to the functions of the information processing device 52 according to the first embodiment, a biometric information acquisition unit 5209 and a destination determination unit 5210.

The biometric information acquisition unit 5209 acquires biometric information of a specified third user. Specifically, the biometric information acquisition unit 5209 receives biometric information transmitted (uploaded) from a third client device owned by a third user. The timing for receiving the biological information may be at a regular interval or at a specific time. The third client device owned by the third user is, for example, a wearable terminal. The biological information includes blood pressure, heart rate, body temperature, brain waves, sound, or the like. The biological information is not limited thereto, but may be information that can specify emotions, psychological states, or the like of the third user.

The destination determination unit 5210 determines, based on the biological information acquired by the biometric information acquisition unit 5209, a third user satisfying a specification condition as a destination of at least one of the first specification and information the second specification information. The destination determination unit 5210 also instructs the information transmission unit 5206 to transmit at least one of the first specification information and the second specification information to the determined destination.

For example, when a specification condition is that a heart rate of a third user acquired by the biometric information acquisition unit 5209 is less than a threshold 100 bpm, the destination determination unit 5210 determines that the emotion of the third user satisfying the specification condition is stable, and determines a third client device owned by the third user as a destination of at least one of the first specification information and the second specification information. Then, the destination determination unit 5210 transmits an instruction to permit transmission of the information to the third user to the information transmission unit 5206.

However, when the heart rate of the third user acquired by the biometric information acquisition unit 5209 exceeds the threshold of 100 bpm, and does not satisfy the specification condition, the destination determination unit 5210 determines that the emotion of the third user is unstable, and excludes the third client device owned by the third user from destinations of at least one of the first specification information and the second specification information. In this case, the destination determination unit 5210 transmits an instruction to the information transmission unit 5206 not to permit transmission of information to the third user.

In addition, the destination determination unit 5210 may monitor whether the blood pressure of the third user is below a threshold, or whether a body temperature is at a normal value, and use the result of predicting a state of the third user being irritated or impatient as a specification condition to instruct to permit or not to permit transmission of information to the third user.

In addition, the destination determination unit 5210 may use the result of predicting a state of an autonomic nervous system (whether a sympathetic or parasympathetic nervous system is dominant) or the like, based on a brain wave or the like of a third user as a specification condition. In addition, the destination determination unit 5210 may use the result of predicting a state of the third user being exalted, normal, or irritated as a specification condition based on a facial expression of the third user and the inflection of a sound.

By determining whether or not to make a third user as a destination of information in consideration of emotions of the third user, information about the place where the first user or the like gather can be provided only to a third user in the calm state. Therefore, it is possible to transmit information only to users who are highly likely to move to the place. Thus, the transmission of information to a third user who is unlikely to move to the place where the first user or the like gather is prevented, and the load on the server 5 and the network NW can be prevented from increasing.

### Fourth Embodiment

The information processing device 52 according to the fourth embodiment includes, in addition to the function of the information processing device 52 according to the first embodiment, a transmission confirmation unit which confirms whether a first user or a second user can transmit information to a third user, and a transmission instruction unit which instructs the information transmission unit 5206 to execute a transmission when the first user or the second user permits the transmission in response to an inquiry from the transmission confirmation unit.

The transmission confirmation unit may display a button such as “transmission OK” or “transmission NO” on the screen of the first client device owned by the first user or the second client device owned by the second user. When the “transmission OK” button is pressed, the transmission instruction unit instructs the information transmission unit 5206 to execute a transmission. The transmission instruction unit may be configured to instruct the information transmission unit 5206 to execute a transmission by a voice operation such as “transmission OK to the third user”.

With this configuration, the first user or the second user can set whether to permit transmission of information before the information transmission unit 5206 transmits the information to the third user. In other words, the first user or the second user can restrict the transmission target. In addition, compared with a case where information is always transmitted to the third user, the load on the server 5 and the network NW can be prevented from increasing.

Note that the functions of the server 5 described in Embodiments 1 to 4 may be provided in either the terminal 2 which is a client device, or in the in-vehicle unit 30. Note that two or more of Embodiments 1 to 4 may be combined.

### (Supplementary Note)

The information processing device, reception device, information processing method, or non-transitory computer-readable storage medium according to the embodiments may be configured as the information processing device, information processing method, or non-transitory computer-readable storage medium described in the following items.

(Item 1) An information processing device comprising: a first information acquisition unit configured to acquire first specification information including first position information indicating a position of a first transmission device owned by a first user, and first address information registered in the first transmission device; a second information acquisition unit configured to acquire second specification information including second position information indicating a position of a second transmission device owned by a second user, and second address information registered in the second transmission device; an encounter determination unit configured to determine whether the first user and the second user have encountered each other, based on the first specification information and the second specification information; a user specifying unit configured to specify a third user based on the first address information and the second address information when the first user and the second user have encountered each other; and an information transmission unit configured to transmit at least one of the first specification information and the second specification information to a reception device owned by the third user.

(Item 2) The information processing device according to item 1, further comprising: a history information acquisition unit configured to acquire outing histories of the specified third user; and a destination determination unit configured to specify a third user satisfying a specification condition from among a plurality of the third users based on the outing histories, and determine the reception device owned by the specified third user as a destination of at least one of the first specification information and the second specification information, wherein the destination determination unit instructs the information transmission unit to transmit at least one of the first specification information and the second specification information to the determined destination.

(Item 3) The information processing device according to item 1 or item 2, further comprising: a biological information acquisition unit configured to acquire biological information of the specified third user; and a destination determination unit configured to determine, based on the biological information, the reception device owned by the third user satisfying the specification condition as a destination of at least one of the first specification information and the second specification information, wherein the destination determination unit instructs the information transmission unit to transmit at least one of the first specification information and the second specification information to the determined destination.

(Item 4) A reception device configured to receive information from an information processing device, wherein the reception device receives at least one of first specification information including first position information indicating a position of a first transmission device owned by a first user and second specification information including second position information indicating a position of a second transmission device owned by a second user from the information processing device, and displays information about the first user and the second user on a display unit based on at least one of the first specification information and the second specification information.

(Item 5) An information processing method by an information processing device, comprising: acquiring first specification information including first position information indicating a position of a first transmission device owned by a first user, and first address information registered in the first transmission device; acquiring second specification information including second position information indicating a position of a second transmission device owned by a second user, and second address information registered in the second transmission device; determining whether the first user and the second user have encountered each other, based on the first specification information and the second specification information; when the first user and the second user have encountered each other, specifying a third user based on the first address information and the second address information; and transmitting at least one of the first specification information and the second specification information to a reception device owned by the third user.

(Item 6) A non-transitory computer-readable storage medium storing a program for causing a computer to execute: acquiring first specification information including first position information indicating a position of a first transmission device owned by a first user, and first address information registered in the first transmission device; acquiring second specification information including second position information indicating a position of a second transmission device owned by a second user, and second address information registered in the second transmission device; determining whether the first user and the second user have encountered each other, based on the first specification information and the second specification information; when the first user and the second user have encountered each other, specifying a third user based on the first address information and the second address information; and transmitting at least one of the first specification information and the second specification information to a reception device owned by the third user.

The embodiments have been described in detail above. However, it is clear to those skilled in the art that the embodiments are not limited to those described in the embodiments. The embodiments may be implemented as a modifications or variations without departing from the gist and scope of the embodiments defined by the description of the claims. Therefore, the description of the embodiments are for illustrative purposes only and is not meant be limitative in any way to the embodiments.

What is claimed is:

1. An information processing device comprising:
a history information acquisition unit configured to acquire outing histories of a plurality of third users specified based on first address information registered in a first transmission device owned by a first user, and second address information registered in a second transmission device owned by a second user,
a destination determination unit configured to specify a third user satisfying a specification condition from among the plurality of third users based on the outing histories, and determine a reception device owned by the specified third user, as a destination of at least one of first specification information including first position information indicating a position of the first transmission device, and second specification information including second position information indicating a position of the second transmission device, and
an information transmission unit configured to transmit at least one of the first specification information and the second specification information to the reception device determined as the destination, wherein:
the destination determination unit instructs the information transmission unit to transmit at least one of the first specification information and the second specification information to the determined destination.

2. The information processing device according to claim 1, further comprising a biological information acquisition unit configured to acquire biological information of the third user,
wherein the destination determination unit determines, based on the biological information acquired by the biological information acquisition unit, the reception unit owned by the third user satisfying the specification condition as the destination of at least one of the first specification information and the second specification information.

3. The information processing device according to claim 1, further comprising:
an encounter determination unit configured to determine whether the first user and the second user have encountered each other, based on the first specification information and the second specification information, and
a user specification unit configured to specify the plurality of third users based on the first address information and the second address information when the first user and the second user have encountered each other.

4. An information processing method by an information processing device, including:
acquiring outing histories of a plurality of third users specified based on first address information registered in a first transmission device owned by a first user and second address information registered in a second transmission device owned by a second user,
specifying a third user satisfying a specification condition from among the plurality of third users based on the outing histories, and determining a reception device owned by the specified third user, as a destination of at least one of first specification information including first position information indicating a position of the first transmission device and second specification information including second position information indicating a position of the second transmission device, and
transmitting at least one of the first specification information and the second specification information to the reception device determined as the destination.

5. A non-transitory computer-readable storage medium storing a program to cause a computer to execute:
acquiring outing histories of a plurality of third users specified based on first address information registered in a first transmission device owned by a first user, and second address information registered in a second transmission device owned by a second user,
specifying user satisfying a specification condition from among the plurality of third users based on the outing histories, and determining a reception device owned by the specified third user, as a destination of at least one of information including first position first specification information indicating a position of the first transmission device, and second specification information including second position information indicating a position of the second transmission device, and
transmitting at least one of the first specification information and the second specification information to the reception device determined as the destination.
